(19) United States
(12) Patent Application Publication
(10) Pub. No.: US 2009/0078380 A1
(43) Pub. Date: Mar. 26, 2009

(54) Damping apparatus for retraction and extension of window shades

(76) Inventor: Li-Ming Cheng, Kaohsiung City (TW)

Correspondence Address: Frenkel & Associates, P.C., Suite 330, 3975 University Drive, Fairfax, VA, 22030, US

(21) Appl. No.: 11/904,074

(22) Filed: Sep. 26, 2007

(51) Int. Cl. E06B 9/00

(52) U.S. Cl. 160/291

(57) ABSTRACT

A damping apparatus for retraction and extension of window shades includes a damper and a damper casing that are pivotally coupled with a clutch and engaged with a rolling shade or a window shade assembly. A sealed housing chamber is formed between the damper and damper casing to contain damping oil. The damper casing has a shaft at one end pivotally coupled with the clutch and a jutting stem at another end to couple with a transmission axle of a main spring of the rolling shade. The damper has an axle rotating relative with a shell to generate volume alteration of a curved surface at one end such that the apparatus can control deceleration while the rolling shade is retracted or buffer the extension speed while the window shade assembly is extended.

### FIELD OF THE INVENTION

The present invention relates to a window shade accessory and particularly to a damping apparatus for retraction and extension of window shades.

### BACKGROUND OF THE INVENTION

A window shade usually aims to block sunshine or serve ornamental purpose. Extension and retraction of rolling window shades or independent panel shades mostly are done manually or through a lift cord. Some window shades also are equipped with a damping apparatus A which has a housing trough A10 containing lubricant B to generate a damping effect on a propeller A21 coupled at one end of an axle A20 that is extended and submerged in the lubricant B (referring to FIG. 1). However, the damping apparatus A still has drawbacks in practice, notably:

1. after the window shade has been extended to the bottom end and to be released for rolling up, the main transmission shaft c rotates and drives the propeller A21 coupled at the other end of the damping apparatus A, and the lubricant B is slapped during rotation. A great instant resistance occurs during the rotation, and an excessive torsional force could be generated and result in damage of machine elements. Malfunction often happens. It also is difficult to control slow down of retraction or extension of the window shade.

### SUMMARY OF THE INVENTION

The primary object of the present invention is to provide a damping apparatus for retraction and extension of window shades to overcome the problem of the conventional techniques that cannot optimally control buffer speed. The damping apparatus of the invention may be installed at one end of a rolling shade and pivotally coupled with a clutch to facilitate deceleration of window shade retraction. It is also adoptable to a window shade assembly to buffer the extension speed.

To achieve the foregoing object the damping apparatus of the invention includes a damper and a damper casing that are pivotally coupled with a clutch to be incorporated with a rolling shade or a window shade assembly. The damper has one end with a curved surface formed thereon to be submerged in a sealed housing chamber formed in the damper casing containing damper oil. The curved surface is alterable when the axle of the damper rotates relative to a shell. The damper casing has a shaft at one end pivotally coupled with the clutch and a stem at another end to couple with a transmission shaft of a main spring of the rolling shade. The damper can provide a buffer effect to control retraction speed of the rolling shade or extension speed of the window shade assembly.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional damping apparatus.

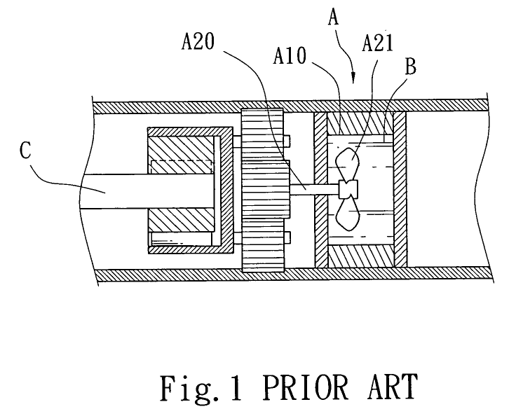

FIG. 2 is an exploded view of the invention.

FIG. 3 is a fragmentary sectional view of the invention.

FIG. 4 is a sectional view of the invention.

FIG. 5 is a schematic view of the damping apparatus of the invention coupling with a rolling shade (for retraction).

FIG. 6 is a schematic view of the damping apparatus of the invention coupling with a window shade assembly (for extension).

FIG. 7A is an exploded view of the damping apparatus of the invention adopted for a window shade assembly.

FIG. 7B is a cross section taken on line 7B-7B in FIG. 7A.

FIG. 8 is a schematic view according to FIG. 7A in an assembled condition.

### DETAILED DESCRIPTION OF THE PREFERRED EMBODIMENTS

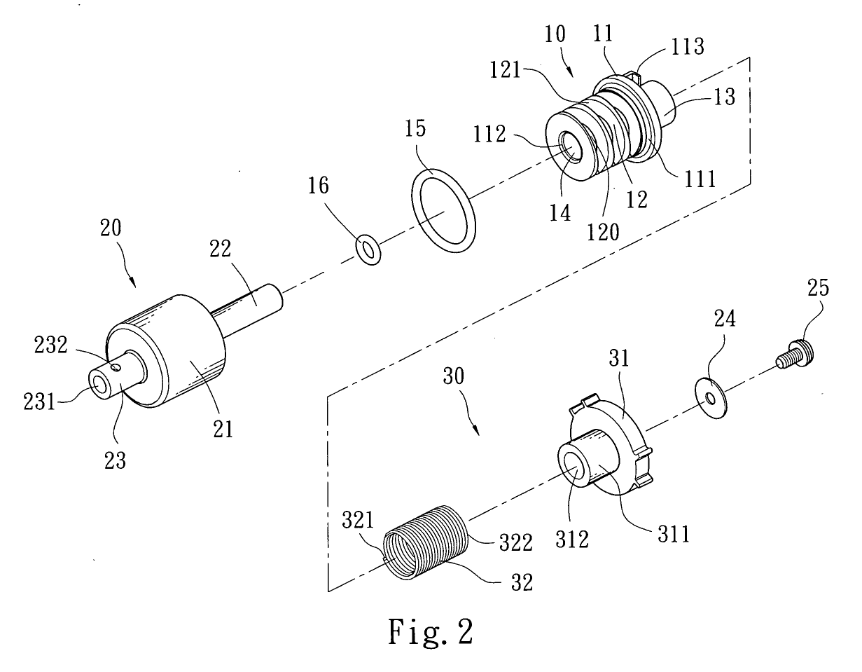

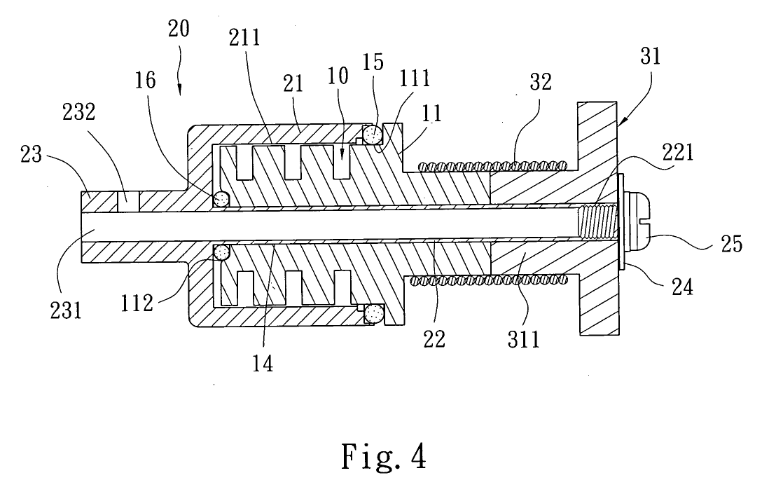

Please refer to FIGS. 2 through 5, the damping apparatus for retraction and extension of window shades according to the invention mainly includes a damper 10 and a damper casing 20 that may be pivotally coupled with a clutch 30 to be used on a rolling shade 40 and a window shade assembly 50.

The damper 10 has a jutting ring 11 which has one or more curved surfaces 12 and 121 at one end that generate volume alterations when an axle 120 at one end rotates relative to a shell 21 and a jutting strut 13 at another end, and a through hole 14 in the center running through the two ends thereof. The jutting ring 11 has a first indented ring 111 and a second indented ring 112 at the top and bottom surface thereof to be coupled respectively with a first sealing pad 15 and a second sealing pad 16, and an extrusion 113 extended from another end surface.

The damper casing 20 encases the damper 10, and has a housing chamber 211 formed in the shell 21, and a shaft 22 in the center that has a fastening hole 221 in the center, and a jutting stem 23 at another end that has a through hole 231 and a latch hole 232 on the periphery.

The clutch 30 is engaged with one side the damper 10. It mainly includes a jutting flange 31 and an elastic element 32. The jutting flange 31 has one end extended to form a jutting rod 311 which has a hole 312 to allow the shaft 22 of the damper casing 20 to pass through. The elastic element 32 is coupled on the jutting strut 13 and the jutting rod 311 from outside, and has one end 321 latched in the extrusion 113 of the damper 10 and another end 322 held in the jutting flange 31.

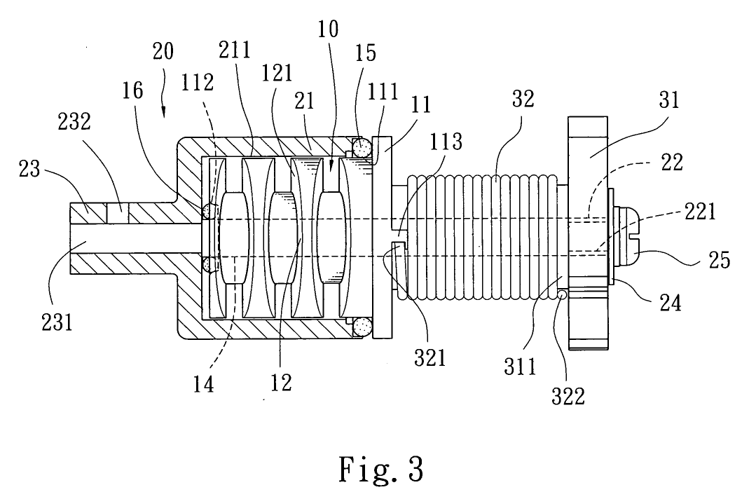

Referring to FIGS. 3, 4 and 5, for assembly the damper 10 is held in the damper casing 20 which is filled with the damping oil; wedge the first sealing pad 15 in the first indented ring 111, and the second sealing pad 16 in the second indented ring 112 to seal the housing chamber 211; couple the damper 10 with the clutch 30 in a pivotal manner and fasten to the shaft 22 through a washer 24 and a fastening element 25 to become an integrated body; couple the through hole 231 of the jutting stem 23 with an axle 41 of the rolling shade 40 and fasten them by screwing a fastening element 42 into the latch hole 232 to finish the assembly.

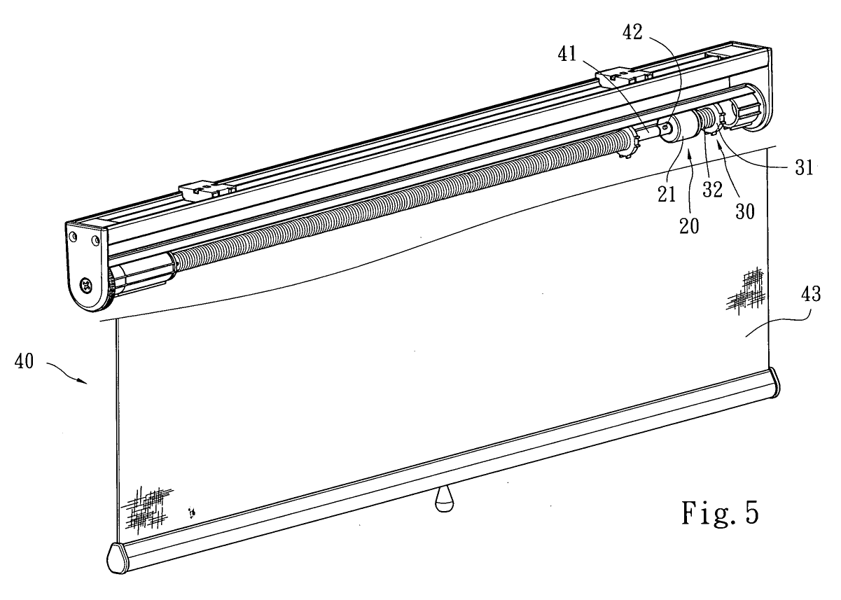

Referring to FIG. 5, when in use the damping apparatus of the invention may be coupled with the rolling shade 40. When to retract a window shade 43 in the counterclockwise direction, the jutting flange 31 of the clutch 30 also rotates in counterclockwise direction. As the rotational direction is same as the helical direction of the elastic element 32, a coupling condition is established with the clutch 30, hence the jutting strut 13 of the damper 10 also is driven and rotated, and the damper 10 held in the housing chamber 211 rotates relative to the axle 41. While the axle 120 of the damper 10 rotates relative to the shell 21, the curved surfaces 12 and 121 submerged in the damping oil alter the volume, hence a damping effect from a low speed to a fast speed is generated. Thus the retraction speed of the window shade 43 is decelerated. When to extend the window shade 43 by rotating in the clockwise direction, the clutch 30 also rotates in the clockwise direction. As the rotational direction is against the helical direction of the elastic element 32, no coupling relationship is established with the clutch 30. The jutting flange 31 rotates but does not drive the jutting strut 13 of the damper 10. Hence the damper 10 does not rotate while the clutch 30 rotates, and remains in a still condition. The clutch 30 rotates idly on the damper 10. Thus extension of the window shade 43 is not hindered and can proceed smoothly.

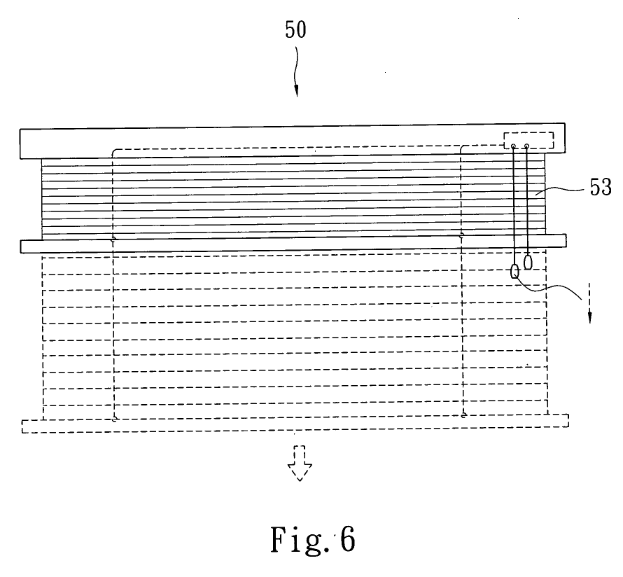

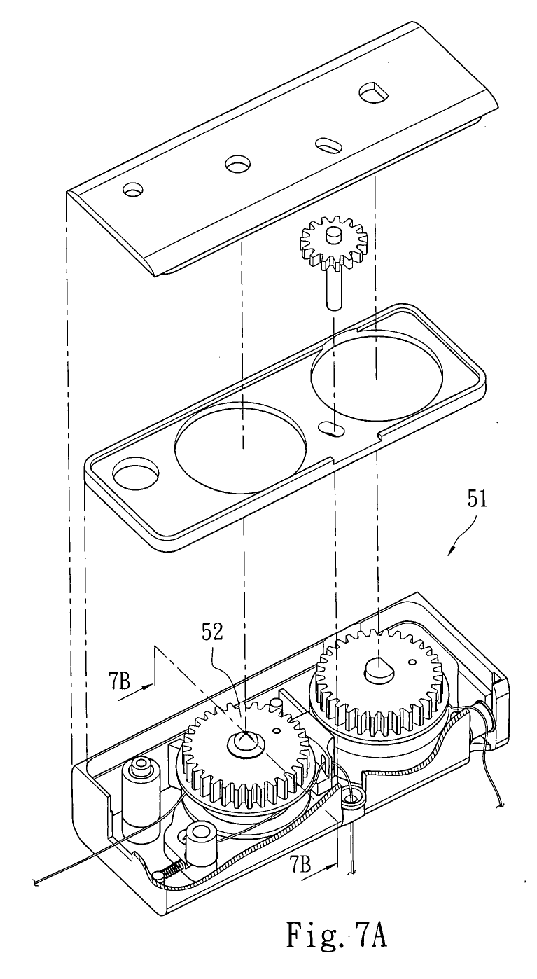

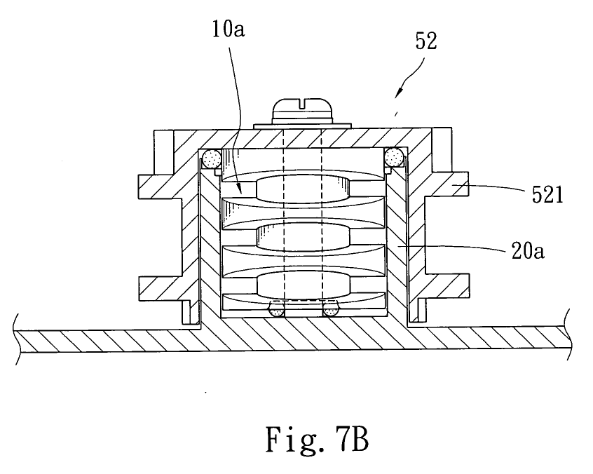

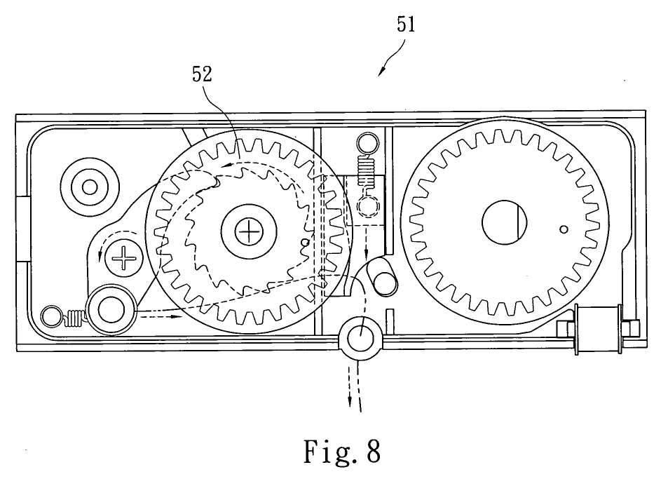

Referring to FIGS. 6 through 8, the damping apparatus may also be formed by coupling a damper 10a with a damper casing 20a. Such a structure can be flexibly adapted to various types of installations and applications. For instance it can be installed on a back side of a pulley 521 of a latch roller set 52 of a lift cord control means 51 at one end of the window shade assembly 50. When a window shade 53 is extended in the counterclockwise direction, the damper 10a and the latch roller set 52 rotate counterclockwise at the same time. The damping oil filled between the damper 10a and the damper casing 20a generates a damping effect to decelerate the extension speed of the window shade 53. When the window shade 53 is retracted along the clockwise rotation, the damping apparatus also rotates clockwise without encountering any hindrance, and an idle rotation is formed. Thus retraction of the window shade 53 can proceed smoothly.

As a conclusion, the damping apparatus of the invention can be coupled with a rolling shade 40 and a window shade assembly 50 to decelerate retraction of the rolling shade 40 and window shade 43, and make extension of the rolling shade 40 and window shade 53 smoother. It is adaptable easily to various types window shades.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A damping apparatus for retraction and extension of window shades, comprising a damper and a damper casing that are pivotally coupled with a clutch and engaged with a rolling shade, wherein:
the damper has a jutting ring which has at least one curved surface at one end that generates volume alterations for a fluid contained in a shell of the damper casing when an axle of the damper rotates relative to the shell and a jutting strut at another end, and a through hole in the center running through the two ends thereof; and
the damper casing encases the damper and has the shell contained inside to form a housing chamber and a shaft in the center of one end and a jutting stem at another end thereof.

2. The damping apparatus of claim 1, wherein the jutting ring has a first indented ring and a second indented ring at the top and the bottom surface thereof to be coupled respectively with a first sealing pad and a second sealing pad to form a tight sealing with the damper casing.

3. The damping apparatus of claim 1, wherein the jutting ring of the damper has an extrusion at one end surface to latch one end of an elastic element.

4. The damping apparatus of claim 1, wherein the shaft of the damper casing has a fastening hole formed thereon.

5. The damping apparatus of claim 1, wherein the jutting stem has a through hole and a latch hole formed on the periphery thereof.

6. The damping apparatus of claim 1, wherein the damper and the housing chamber of the damper casing form a space there between filled with damping oil.

7. The damping apparatus of claim 1, wherein the clutch is engaged with one side of the damper and includes a jutting flange and an elastic element, the jutting flange having one end extended to form a jutting rod which has a hole to allow the shaft of the damper casing to pass through, the elastic element being coupled on the jutting strut and the jutting rod from outside and having two ends latched respectively on an inner side of the jutting ring and the jutting flange.

8. The damping apparatus of claim 1 further including a damper and a damping casing engaged with a window shade assembly.
